(19) United States
(12) Patent Application Publication
(10) Pub. No.: US 2002/0111815 A1
(43) Pub. Date: Aug. 15, 2002

(54) System and method for enabling users of gaming activities to automate their tax deductible and charitable contributions

(75) Inventor: Gordon James Smith, Rochester, MN (US)

Correspondence Address: Andrew J. Dillon, BRACEWELL & PATTERSON, LLP, Suite 350, Lakewood on the Park, 7600B North Capital of Texas Highway, Austin, TX, 78731, US

(73) Assignee: International Business Machines Corporation

(21) Appl. No.: 09/781,010

(22) Filed: Feb. 9, 2001

(51) Int. Cl. G06F 17/60

(52) U.S. Cl. 705/1

(57) ABSTRACT

A business method and system for making charitable contributions allows users of gaming systems, such as games of chance, to automatically improve their odds of winning or potential payout amount. The system enables gaming system users to designate a portion of their funds or net proceeds from gaming activities to be donated to charity of their choice. The donations are automatically made and funded to authorized charities or non-profit organizations and the balance of the net proceeds are distributed to the players. In addition, the system also complies with any Internal Revenue Service reporting that is required by law.

### BACKGROUND OF THE INVENTION

1. Technical Field

This invention relates in general to facilitating tax deductible and charitable contributions, and in particular to a method and system for making charitable contributions electronically. Even more particularly, the invention relates to a system and method for enabling users of gaming machines and systems to automatically make and fund charitable contributions.

2. Description of the Related Art

Charitable and non-profit organizations are typically required to raise money or solicit gifts in order to fund their operations. A donor is usually requested to make a pledge, and then later to honor the pledge. A problem with this type of fund raising is that some of the pledges do not get honored. Some donors forget about their pledge, while others do not have adequate funds available with them to make the desired contribution or gift. Another factor is that the donor's financial situation may suffer between the time of making the pledge and the time of honoring the pledge, such that adequate resources are no longer available to make the contribution.

In addition, the impulse for a donor to make a pledge is maximized at the time a pledge is solicited. In particular, if a donor's financial situation suddenly improves, such as when a donor experiences success at games of chance, the donor may be inclined to be more generous. However, the impulse dissipates over time and as such is less likely to be fulfilled over prolonged durations. As a result, charitable organizations can lose significant revenue that would have been used to continue their efforts because of their inability to access donors during such events. Thus, a need exists to enable would-be donors with the means to immediately and automatically provide contributions to charitable organizations.

### SUMMARY OF THE INVENTION

One embodiment of a business method and system for making tax deductible or charitable contributions allows users of gaming systems, such as games of chance, to automatically improve their odds of winning or potential payout amount. The system enables gaming system users to designate a portion of their funds or net proceeds from gaming activities to be donated to recipient or charity of their choice. The donations are automatically made and funded to authorized charities or non-profit organizations and the balance of the net proceeds are distributed to the players. In addition, the system also complies with any Internal Revenue Service reporting that is required by law.

The foregoing and other objects and advantages of the present invention will be apparent to those skilled in the art, in view of the following detailed description of the preferred embodiment of the present invention, taken in conjunction with the appended claims and the accompanying drawings.

### BRIEF DESCRIPTION OF THE DRAWINGS

So that the manner in which the features, advantages and objects of the invention, as well as others which will become apparent, are attained and can be understood in more detail, more particular description of the invention briefly summarized above may be had by reference to the embodiment thereof which is illustrated in the appended drawings, which drawings form a part of this specification. It is to be noted, however, that the drawings illustrate only a preferred embodiment of the invention and are therefore not to be considered limiting of its scope as the invention may admit to other equally effective embodiments.

FIG. 1 depicts a schematic diagram of an illustrative embodiment of an automated interface constructed in accordance with the method and system of the present invention.

FIG. 2 is a layer diagram of programs in a data processing system of FIG. 1 that cooperate to automatically connect to a remote data processing system according to the method and system of the present invention.

FIG. 3 is a schematic diagram of an optional user interface terminal for the data processing system of FIG. 1.

FIG. 4 is a high level, logical flowchart of an illustrative embodiment of the method and system of the present invention utilized by the automated interface of FIG. 1.

FIG. 5 is a schematic block diagram of the user interface terminal of FIG. 3.

FIG. 6 is a schematic diagram of another version of the present invention.

FIG. 7 is a high level flowchart of one adaptation of the present invention.

FIG. 8 is a high level flowchart of another adaptation of the present invention.

### DETAILED DESCRIPTION OF THE PREFERRED EMBODIMENT

The present invention may be executed in a variety of systems including computer systems having various operating systems. The computer system may be a personal computer, a network computer, a midrange computer or a mainframe computer. In addition, the computer may be a stand-alone system or part of a network such as a local-area network (LAN) or a wide-area network (WAN). For the purposes of illustration, one embodiment of the present invention, as described below, is implemented utilizing a personal computer.

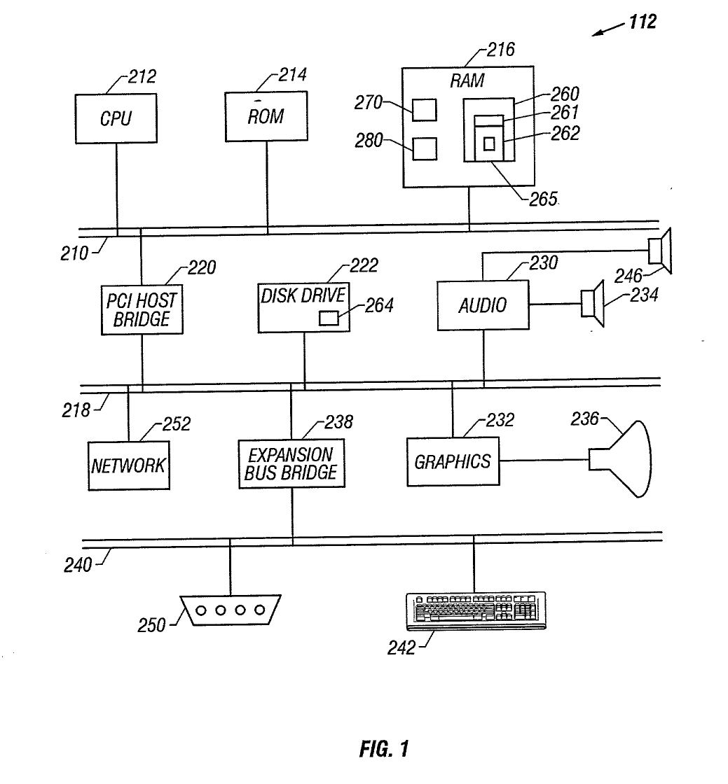

Referring now to FIG. 1, there is depicted a block diagram of a server 112. Server 112 includes a system bus 210 that is connected to a central processing unit (CPU) 212 and to memory, including read only memory (ROM) 214 and random access memory (RAM) 216. System bus 210 is coupled to a PCI local bus 218 through a PCI host bridge 220. PCI local bus 218 is connected to additional nonvolatile data storage devices, such as one or more disk drives 222, and to an audio adapter 230 and a graphics adapter 232 for controlling audio output through a speaker 234 and visual output through a display device 236, respectively. A PCI-to-ISA bus bridge, such as expansion bus bridge 238, connects PCI local bus 218 to an ISA bus 240, which is attached (through appropriate adapters) to a keypad 242 for receiving operator input. A microphone of other audio input device 246 is connected to audio adapter 230.

Also included within server 112 are data ports for communicating with external equipment, such as other data processing systems. The data ports include, without limitation, a serial port 250 attached to ISA bus 240 for linking server 112 to remote data processing systems (such as a bridge) via a modem (not illustrated) and a communications adapter 252 attached to PCI bus 218 for linking server 112 to other stations of a LAN (such as clients).

Server 112 also contains software applications that are stored on the data storage devices and loaded into RAM 216 for execution by CPU 212. Among those applications is a communications program, such as communications manager 260, that manages the exchange of information between the LAN and remote data processing systems. Included in communications manager 260 is a connection initiator 261 for establishing dial-up connections to remote data processing systems. Communications manager 260 also includes Internet sharing software 262 that enables multiple LAN stations to access the Internet via a single connection. In the illustrative embodiment, server 112 also includes a connection schedule file 264, which preferably is stored in disk drive 222, and Internet sharing software 262 includes a request predictor 265 that utilizes connection schedule file 264 to trigger connection initiator 261 in advance of anticipated communication requests.

Connection schedule file 264 is maintained by a schedule editor and/or an automatic schedule modifier, each of which is preferably also included in Internet sharing software 262. Server 112 also includes a Web browser 270 and an E-mail client 280 that allow an operator of server 112 or client to retrieve and view information from the Internet and send and receive E-mail via the Internet, respectively.

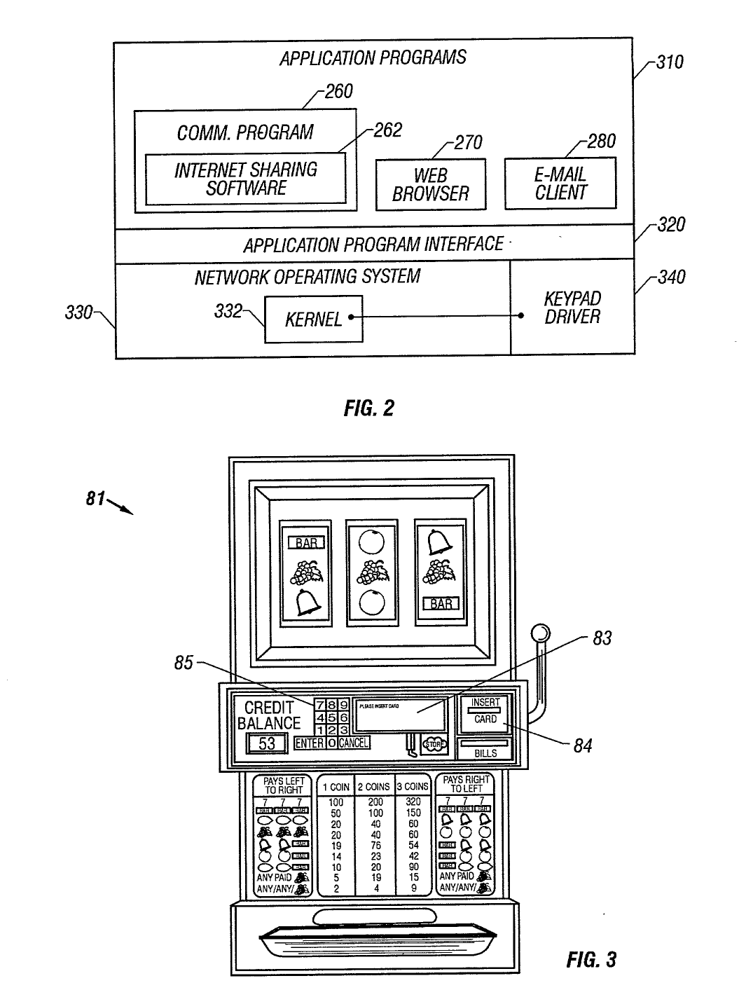

With reference now to FIG. 2, there is depicted a layer diagram of the software applications within server 112 that cooperate to provide the functionality of the present invention according to the illustrative embodiment. At the highest level of the layer diagram are the software application programs 310, including communications manager 260, web browser 270, and E-mail client 280. At the intermediate level is an application program interface (API) 320, through which application programs 310 request services from the operating system 330. Operating system 330, which occupies the lowest level of the layer diagram, is a network operating system. As such, in addition to managing the operations of server 112 (by performing duties such as resource allocation, task management, and error detection), operating system 330 also provides tools for managing communications within the LAN and between LAN stations and remote data processing systems. Included within operating system 330 is a kernel 332 that manages the memory, files, and peripheral devices of server 112. The lowest level also includes device drivers, such as a keypad driver 340 that kernel 332 utilizes to manage input from and output to peripheral devices.

For purposes of illustration of the present invention, a gaming system having a play station, such as a slot machine (FIG. 3), is equipped with a user interface terminal 81. Terminal 81 includes a display screen 83 for graphically interfacing with the user, a data storage device reader 84, and option buttons 85 that can be selected by the user when prompted by the system. Terminal 81 is merely symbolic of means that can be used to initiate a charitable contribution according to the present invention.

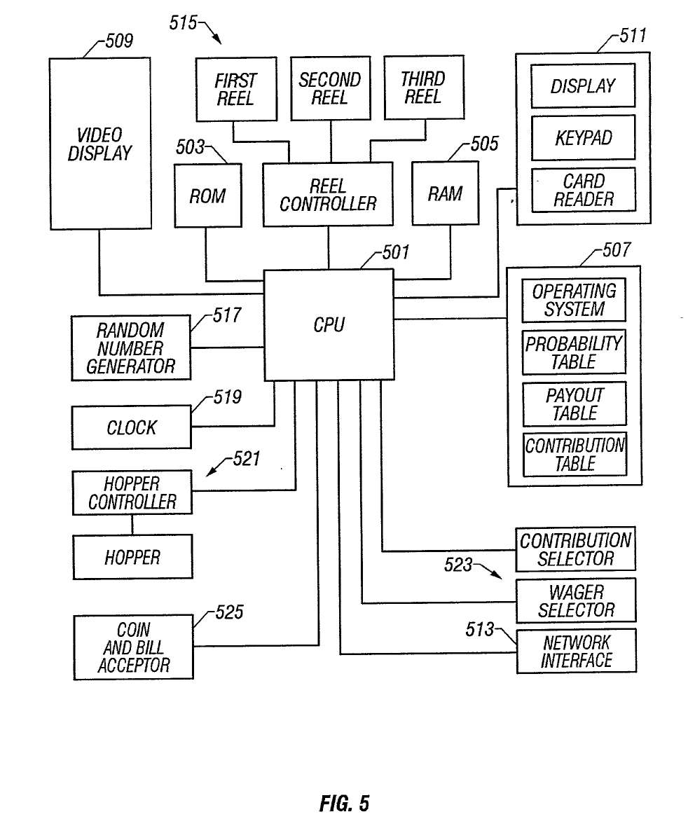

FIG. 5 is a block diagram of one embodiment of the user interface terminal of FIG. 3 having a central processing unit (CPU) 501 with memory, including read only memory (ROM) 503 and random access memory (RAM) 505. CPU 501 is coupled to a data storage device 507 and a display device 509. An operator input device 511 utilizes a keypad or the like for receiving operator input. Also included within the terminal is a data port 513 for communicating with external equipment, such as other data processing systems. In the illustrative embodiment, the terminal is a slot machine (manual or electronic) having traditional hardware including, for example, a reel system 515, a random number generator 517, a clock 519, a hopper system 521, a wager system 523, and means 525 for accepting wagers.

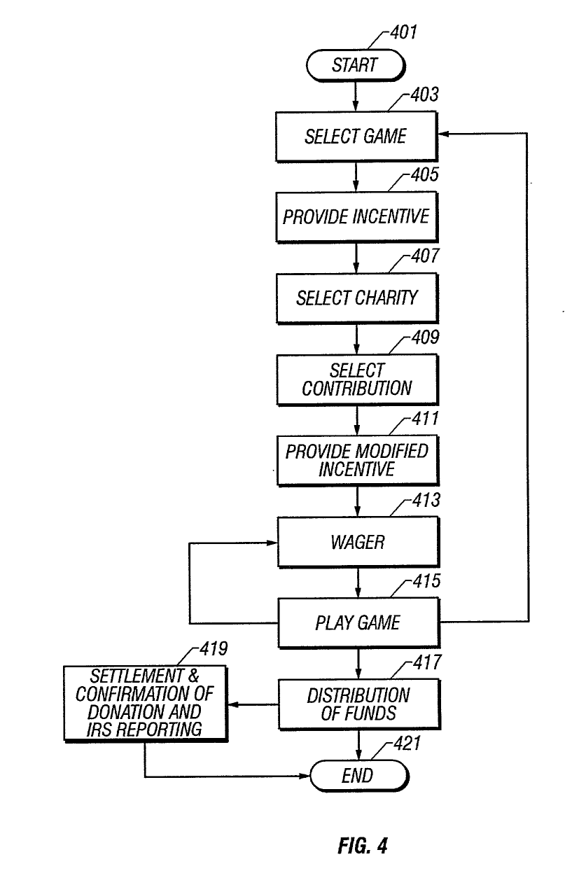

Referring now to FIG. 4, there is illustrated one embodiment of a high level, logic flow diagram of a method for generating income for charitable or non-profit organizations according to the present invention. The method prompts players of gambling or gaming systems such as games of chance in casinos or “internet gambling” with options for making charitable contributions during the gaming activity. In the preferred embodiment, the present invention automatically increases a player's odds of winning a game or the potential payout based upon the size or amount of the charitable contribution designated by the player. The charitable contribution may be funded in many different ways, including but not limited to internal payment systems facilitated by a gaming facility (e.g., “chips”), data storage devices such as credit cards, debit cards, SMART cards, etc. The gaming activity and charitable contributions may take place at traditional, manually-facilitated gaming venues, automated, self-service oriented gaming interface terminals, or any combination thereof. The present invention is also capable of tracking the contributions of players across multiple gaming terminals and venues, even if a player uses different methods of funding the contributions. Alternatively, the present invention is also adapted to track the contributions of players at different gaming houses or entities, or any combination of these scenarios.

In one embodiment of the present invention, a gaming entity such as a gaming house has a game or gaming machine for the use and enjoyment of patrons or players. For example, an electronic slot machine is equipped with a remote terminal 81 (FIG. 3), and the algorithm begins as illustrated at block 401 (FIG. 4). In this example, the gaming machine may provide the player with a choice of more than one type of game, as depicted in block 403. As illustrated at block 405, after the player selects a game, the odds of winning the game and/or the potential payout(s) of the game (should the player prevail) may be optionally presented or displayed to the player. The player is given the opportunity to select charitable or non-profit organization to which he or she would like to make a contribution, as depicted at block 407. This step may be accomplished in many ways. For example, the player may be allowed to enter the name of an organization, given a list of pre-selected organizations from which to choose, or allowed to designate a qualifying organization at a later time. Alternatively, a computer associated with the present system may selectively or randomly generate a charitable organization(s) to which the player may donate.

As illustrated at block 409, the player can also be prompted to select the size or specific amount of the charitable contribution, and whether the contribution is contingent upon the player winning the game. For example, the player may choose to donate 10% of the net proceeds or winnings of his or her gaming activities, but not to make a donation if there are no net proceeds. Alternatively, players may make donations from their personal funds, and make such donations either dependent upon or independent of the outcome of the gaming activity. In another embodiment, the net proceeds of the gaming establishment (i.e., the “house”) reduced by a designated percentage with the balance donated to the charity. These or other options also may be selected on a game-by-game basis, for an extended period of gaming activity (e.g., for all games played during a selected weekend), or any permutation thereof. Alternatively, a player can choose to make a charitable contribution regardless of the net outcome of the game or period of gaming activity.

In one embodiment of the present invention, the system automatically adjusts the odds of winning the game and/or the potential payout(s) in proportion to the level of contribution designated by the player, as depicted at block 411. Alternatively, the odds or payout may be adjusted at the request of an organization. For example, if the player indicates that one percent of the net proceeds of the gaming activity are to be donated to charity, the odds of winning the game may be increased only slightly, or the potential payout may be increased by a nominal amount. However, if the player indicates that ten percent of the net proceeds of the gaming activity are to be donated to charity, the odds of winning the game or the potential payout may be increased more significantly. Note that the precise or enhanced odds of winning and/or potential payout(s) need not be displayed to the player.

The wagering or funding means selected by the player for playing a game and/or making a charitable contribution at a gaming venue is illustrated at block 413. This step may require simply placing chips or currency in a designated location, electronic wagering techniques, or other means of wagering, such as inserting, scanning, or reading a data storage device at a terminal. In the future, fingerprints or voiceprints may be used, for example, as the communication or identity means to identify players. Should the player choose to use a data storage device or card for funding or wagering purposes, the card may be utilized in any one of a number of reading devices, including electronic, magnetic, optical, and/or other means. A determination is made as to whether the card is valid, and/or whether a line of credit or debit is authorized by the issuer of the card. If the card is not validated and/or authorized, the process proceeds, for example, by displaying a message within display screen 83 such as “See attendant,” “Authorization denied,” or a similar message for conveying to the user or player that an alternate funding means is required.

As depicted at block 415, the game is then initiated and played. Based upon the selections designated by the player in the previous steps, the distribution of funds takes place subsequent to termination of the game, as illustrated at block 417. For example, if the player prevailed and had designated a 10% donation of the net proceeds for this single gaming activity, only 10% of the net proceeds would be withheld from the player. Under such circumstances, no donation would be made if the player had not prevailed and the wagered amount would be distributed to the house. In another embodiment of the present invention, the player is given the option of canceling his or her donation after a determination is made as to the outcome of the gaming activity. Finally, as illustrated at block 419, settlement and confirmation of the donation and any required Internal Revenue Service (IRS) reporting is completed. In the preferred embodiment, the charitable organization is funded electronically and the player is issued a receipt for accounting or tax purposes. The receipt may be e-mailed or otherwise sent to the player, or issued at the site of the gaming activity. The process then terminates at block 421.

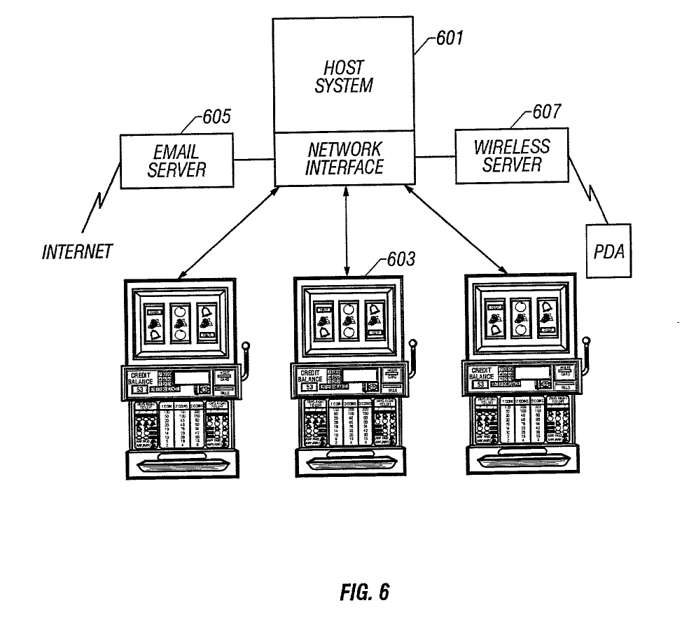

In an alternate embodiment, each player has a “contribution profile” that defines and/or summarizes the individual's contribution activities, including but not limited to a history of contributions to the player's organizations of choice. As shown in FIG. 6, contribution profiles may be stored on a host computer 601 or other devices, such that the contribution profiles can be transmitted directly to gaming devices 603, via e-mail servers 605 to the internet, or wireless servers 607 to devices such as personal data assistants.

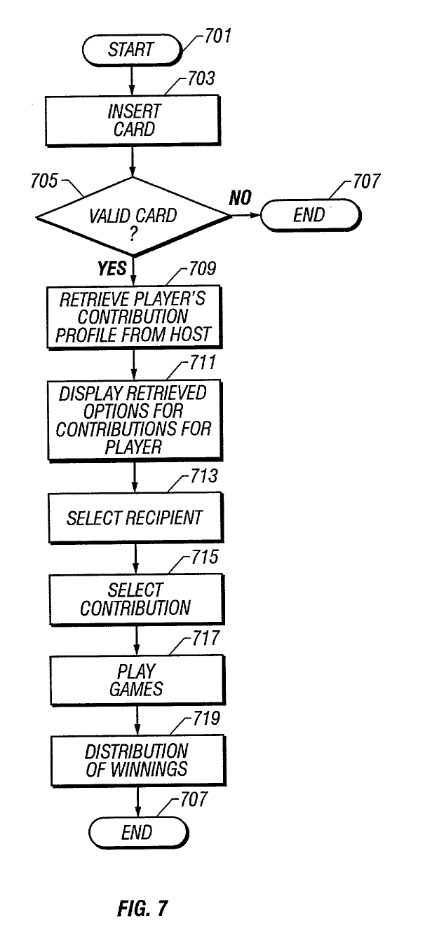

FIG. 7 depicts such an adaptation of the present invention. This version of the method starts at block 701 and, as depicted at block 703, a player inserts a data storage card, which is described above. A determination is made at block 705 as to whether the card is valid. If not, the method ends, as illustrated at block 707. If the card is valid, the method continues and retrieves the player's contribution profile from a host, as depicted at block 709. As illustrated at block 711, appropriate information regarding the player's contribution profile is displayed for the player to make selections, such as the recipient of the contribution (block 713), and the amount of the contribution (block 715). The player then plays the game (block 717) and the winnings are distributed (block 719) in accordance with the previous options selected by the player. The method terminates then terminates, as depicted at block 707.

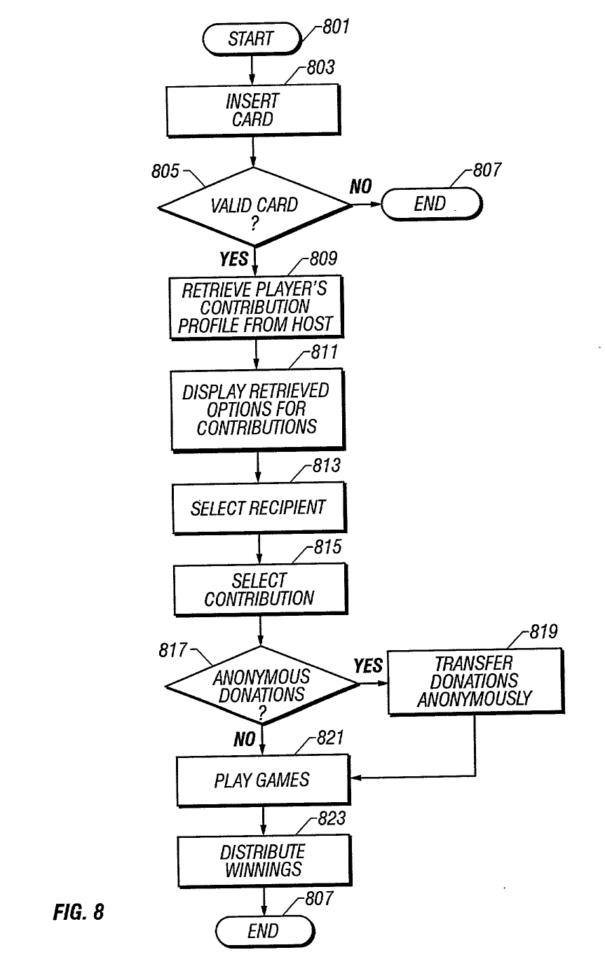

Referring now to FIG. 8, the present invention is also capable of allowing the player to make anonymous contributions. This version of the method starts at block 801 and, as depicted at block 803, the player inserts a data storage card. A determination is made at block 805 as to whether the card is valid. If not, the method ends (block 707), and if the card is valid, the method continues and retrieves the player's contribution profile, as depicted at block 809. As illustrated at block 811, the player's contribution profile is displayed and the player makes selections regarding the recipient of the contribution (block 813), and the amount of the contribution (block 815). As shown at block 817, a determination is made regarding the player's desire to make the contribution anonymous. If so, the contribution is made anonymously (block 819) such that the receiving organization does not know the source of the contribution. If the player wishes to make him or herself known as the contributor, the method simply allows the player to play the game (block 821) and the winnings are distributed (block 823) in the manner previously options described. The method terminates then terminates, as depicted at block 807. Alternatively, anonymous contributions may be made without validating identification by, for example, putting money or other payment means in a machine and keying in a social security number or other identifying number.

The present invention has several advantages. The business method and system motivates and rewards gaming patrons to make many different types of contributions, including donations to charity, non-profit organizations, wildlife preservations, personal retirement accounts, presidential election campaign funds, etc. Preferably, the players and patrons of gaming services are given improved odds of winning and/or larger potential payouts upon winning a game. In addition, donors have the option of making their donations anonymously. Providing gaming patrons with incentives to make donations would offer a significant improvement to the overall welfare of this country and others through the collection of funds in this manner. The present invention also increases the good will of players, gaming establishments, and their employees. In addition, if the names of the charitable organizations are selectively or randomly generated, a more uniform distribution in donations can be realized. In order to maintain equity, certain organizations may not be offered as options in order to more fairly distribute funds.

It is also important to note that, although the present invention has been described in the context of a fully functional computer system, those skilled in the art will appreciate that the mechanisms of the present invention are capable of being distributed as a program product in a variety of forms, and that the present invention applies equally regardless of the particular type of signal-bearing media utilized to actually carry out the distribution. Examples of signal-bearing media include, but are not limited to, recordable-type media such as floppy disks or CD-ROMs and transmission-type media such as analogue or digital communications links. In addition, it should be apparent that the present invention may be employed with alternate means of human personal identification systems, including but not limited to fingerprint identification systems and voice or voiceprint identification systems. Furthermore, many of the steps of the present invention may be offered and performed in a different order than the one presented above.

What is claimed is:

1. A method of automating contributions in a gaming system, said method comprising:
(a) prompting a user with a gaming option;
(b) enabling the user to pledge a contribution to an organization;
(c) permitting the user to make a wager and partake in the gaming option; and
(d) automatically making the contribution to the organization based on the pledge of step (b) and the results of step (c).

2. The method of claim 1 wherein step (b) further comprises allowing the user to select the organization.

3. The method of claim 1 wherein step (b) further comprises allowing the user to select a size of the contribution.

4. The method of claim 1 wherein the gaming option has a first odds of winning in step (a), and a second odds of winning based on the pledge of step (b).

5. The method of claim 1 wherein an odds of winning the gaming option is related to the pledge of step (b).

6. The method of claim 1 wherein the gaming option has a first payout in step (a), and a second payout based on the pledge of step (b).

7. The method of claim 1 wherein a payout for winning the gaming option is related to the pledge of step (b).

8. The method of claim 1, further comprising the step of accumulating contributions for the user during a series of gaming activities.

9. The method of claim 1, further comprising the step of automatically providing information regarding the gaming option and the contribution to the Internal Revenue Service.

10. The method of claim 1 wherein step (b) is satisfied by personal funds of the user.

11. The method of claim 1 wherein a distribution of the contribution is contingent upon the user winning the gaming option.

12. The method of claim 1 wherein the contribution is funded from net proceeds of the gaming system.

13. A method of automating charitable contributions in a gaming system, said method comprising:
(a) prompting a user with a game of chance having a first incentive selected from the group consisting of a first odds of winning and a first payout;
(b) enabling the user to pledge a charitable contribution to a charitable organization;
(c) overriding the first incentive with a second incentive selected from the group consisting of a second odds of winning and a second payout, wherein the second incentive is greater than the first incentive;
(d) permitting the user to make a wager and play the game of chance; and
(e) automatically making the charitable contribution to the charitable organization when the user prevails in the game of chance.

14. The method of claim 13 wherein step (b) further comprises allowing the user to select the charitable organization and a size of the charitable contribution.

15. The method of claim 13, further comprising the step of accumulating charitable contributions for the user during a plurality of gaming activities.

16. The method of claim 13, further comprising the step of automatically providing information regarding the game of chance and the charitable contribution to the Internal Revenue Service.

17. The method of claim 13 wherein step (b) is satisfied by personal funds of the user.

18. The method of claim 13 wherein the charitable contribution is funded from net proceeds of the gaming system.

19. A method of automating charitable contributions in a gaming system, said method comprising:
(a) prompting a user with a game of chance having a first incentive selected from the group consisting of a first odds of winning and a first payout;
(b) allowing the user to select a charitable organization;
(c) enabling the user to pledge a charitable contribution to the charitable organization;
(d) overriding the first incentive with a second incentive selected from the group consisting of a second odds of winning and a second payout, wherein the second incentive is greater than the first incentive;
(e) permitting the user to make a wager and play the game of chance; and
(f) automatically making the charitable contribution to the charitable organization from net proceeds of the user when the user prevails in the game of chance.

20. The method of claim 19, further comprising the step of accumulating charitable contributions for the user during a plurality of gaming activities.
